(19) United States
(12) Patent Application Publication
(10) Pub. No.: US 2010/0231640 A1
(43) Pub. Date: Sep. 16, 2010

(54) LIQUID EJECTING APPARATUS

(75) Inventor: Masakazu TSUZUKI, Suwa-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/704,429

(22) Filed: Feb. 11, 2010

(30) Foreign Application Priority Data
Mar. 13, 2009 (JP) 2009-060738

(51) Int. Cl. B41J 2/165

(52) U.S. Cl. 347/30; 347/32; 347/31

(57) ABSTRACT

A liquid ejecting apparatus includes a liquid ejecting head that performs liquid ejection with respect to an ejection target medium, a carriage that reciprocates with the liquid ejecting head being mounted, a linear encoder that has a linear encoder scale extending in a movement direction of the carriage and a detector which detects the linear encoder scale, a cleaning member that cleans the linear encoder scale, and a recovery unit that recovers the liquid adhered to the cleaning member in a non-ejection area other than an ejection area for performing ejection with respect to the ejection target medium.

The entire disclosure of Japanese Patent Application No. 2009-60738 filed Mar. 13, 2009, is expressly incorporated herein by reference.

### BACKGROUND

1. Technical Field

The present invention relates to a liquid ejecting apparatus including a liquid ejecting head which ejects a liquid, a carriage which reciprocates the liquid ejecting head, and a linear encoder scale.

2. Related Art

As an example of a liquid ejecting apparatus which ejects a liquid to an ejection target medium, an ink jet recording apparatus which ejects ink as a liquid to print on a recording medium (an ejection target medium) such as paper or a recording sheet is widely known in the art.

The ink jet recording apparatus realizes printing on a whole surface of the recording medium by performing one-pass printing by shifting an ink jet recording head in a main-scanning direction with respect to the recording medium and, at the same time, shifting the recording medium in a sub-scanning direction which intersects with the main-scanning direction.

In some patent documents (e.g., JP-A-9-189574, JP-A-2001-121721, JP-A-2005-119164, and JP-A-2005-219437) of the related art, it was proposed to provide a linear encoder in the ink jet recording apparatus in order to detect a position and a speed of the ink jet recording head in a main-scanning direction. Since ink is apt to adhere to a linear encoder scale included in the linear encoder during printing, it was proposed to install a cleaning member for cleaning the linear encoder scale.

However, even when the ink adhered to the linear encoder scale is removed by sliding a cleaning member such as a blade or an absorber installed in the carriage in which the ink jet recording head is mounted, the ink adhered to the blade or absorbed in the absorber may drop onto the recording medium during the printing and pollute the recording medium.

In addition, such a problem is not limited to only the ink jet recording apparatus, but also present in liquid ejection apparatuses which eject liquids other than ink.

### SUMMARY

An advantage of some aspects of the invention is to provide a liquid ejecting apparatus capable of reliably removing a liquid adhered to the linear encoder scale and also preventing the recording medium from being polluted by the removed liquid.

According to an aspect of the invention, there is provided a liquid ejecting apparatus including: a liquid ejecting head that performs liquid ejection with respect to an ejection target medium; a carriage that reciprocates with the liquid ejecting head being mounted; a linear encoder that has a linear encoder scale extending in a movement direction of the carriage and a detector which detects the linear encoder scale; a cleaning member that cleans the linear encoder scale; and a recovery unit that recovers the liquid adhered to the cleaning member in a non-ejection area other than an ejection area for performing ejection with respect to the ejection target medium.

In this case, it is possible to prevent the recording medium from being polluted by the liquid which is adhered to the cleaning member and drops onto the ejection target medium because the liquid adhered to the cleaning member is recovered by cleaning the linear encoder scale. In addition, it is possible to diminish flaws, which may be generated when the liquid adhered to the cleaning member is hardened and the hardened liquid makes sliding-contact with the linear encoder scale, by recovering the liquid adhered to the cleaning member using the recovery unit.

It is preferable to include a memory section that records a driving condition of the liquid ejecting head and a control section that drives the cleaning member based on the driving condition stored in the memory section. As a result, by specifying the frequency of cleaning based on the driving condition recorded in the memory section, it is possible to diminish flaws generated by the cleaning of the linear encoder scale or abrasion of the linear encoder scale without performing unnecessary cleaning.

It is preferable that the cleaning member slides on the linear encoder scale along with the reciprocation of the carriage. As a result, since the carriage dedicated to the cleaning member, a carriage axis, and a driving motor etc. become unnecessary, it is possible to reduce cost.

It is preferable that the cleaning member and the carriage are detachably provided so that the cleaning member stands by in a non-ejection area at an ejection timing when the liquid ejecting head ejects a liquid, and the cleaning member is installed in the carriage and moved together with the carriage at a non-ejection timing when the liquid ejecting head does not eject a liquid. As a result, it is possible to reduce a state in which the liquid adhered to the cleaning member is dripped on the ejection target medium. In addition, it is possible to diminish flaws generated when cleaning the linear encoder scale or abrasion of the linear encoder scale without performing unnecessary cleaning.

It is preferable that the cleaning member is installed in the carriage and constructed such that the liquid cleaned by the cleaning member is delivered to the same surface as a nozzle surface on which a nozzle opening, for ejecting the liquid, of the liquid ejecting head is provided, and, when a suction operation is performed, by a suction unit which covers the nozzle opening, on the nozzle surface, the suction unit simultaneously suctions the liquid cleaned by the cleaning member. As a result, both a suction operation on the nozzle surface of the liquid ejecting head and a recovery operation for the liquid stored in the cleaning member can be simultaneously performed using a single suction unit. Therefore, it is possible to reduce cost by reducing the number of components and facilitating control.

It is preferable that the cleaning member has a deformable member that is elastically deformable and makes sliding-contact with the linear encoder scale and an absorber that is provided in the deformable member and absorbs the liquid recovered by the deformable member through the sliding-contact. As a result, it is possible to efficiently clean the linear encoder scale and prevent the liquid wiped off by the deformable member from dropping onto the ejection target medium.

### BRIEF DESCRIPTION OF THE DRAWINGS

The invention will be described with reference to the accompanying drawings, wherein like numbers reference like elements.

FIG. 1 is a schematic perspective view illustrating a recording apparatus according to a first embodiment of the invention.

FIG. 2 is a cross-sectional view illustrating a recording head according to a first embodiment of the invention.

FIG. 3 is a perspective view illustrating main components of a recording apparatus according to a first embodiment of the invention.

FIGS. 4A and 4B are cross-sectional views illustrating a suction unit and a recovery unit according to a first embodiment of the invention.

FIG. 5 is a perspective view illustrating a cleaning member according to a first embodiment of the invention.

FIG. 6 is a cross-sectional view illustrating a cleaning member according to a first embodiment of the invention.

FIG. 7 is a perspective view illustrating a cleaning state according to a first embodiment of the invention.

FIG. 8 is a block diagram illustrating a control section according to a first embodiment of the invention.

FIG. 9 is a perspective view illustrating main components of a recording apparatus according to a second embodiment of the invention.

FIG. 10 is a cross-sectional view illustrating a carriage according to a third embodiment of the invention.

### DESCRIPTION OF EXEMPLARY EMBODIMENTS

Hereinafter, embodiments of the invention will be described in detail with reference to the accompanying drawings.

### Embodiment 1

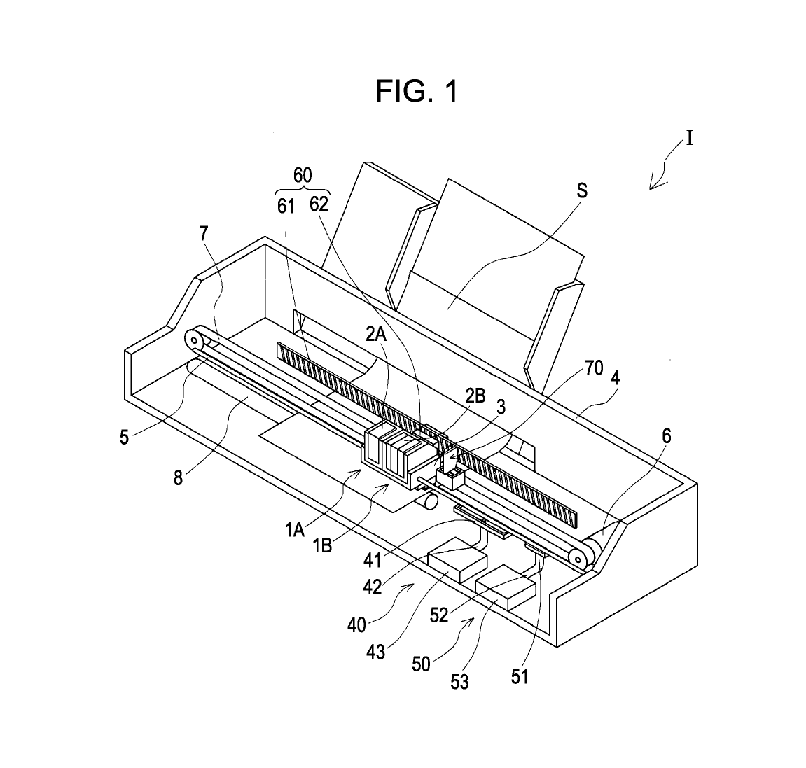

FIG. 1 is a schematic diagram illustrating an ink jet recording apparatus as an example of a liquid ejecting apparatus according to a first embodiment of the invention.

Referring to FIG. 1, in the ink jet recording apparatus I, recording head units 1A and 1B having an ink jet recording head 10 are provided such that ink cartridges 2A and 2B as an ink supply unit are detachably provided and a carriage 3 in which the recording head units 1A and 1B are mounted to move freely in an axial direction of a carriage axis 5 installed in a mainframe 4. The recording head units 1A and 1B discharge, for example, a black ink composition and a color ink composition, respectively.

A driving force of a driving motor 6 is transmitted to the carriage 3 via a plurality of gears and a timing belt (not shown) and the carriage 3 in which the recording head units 1A and 1B are mounted moves along the carriage axis 5. Meanwhile, the mainframe 4 is provided with a platen 8 along the carriage axis 5, and a recording sheet S as a recording medium (i.e., an ejection target medium) such as paper fed from a paper-feed roller (not shown) is wound around the platen 8 and transported.

A non-printing area (i.e., a non-ejection area) laterally located in the platen 8, corresponding to an end portion in a movement direction of the carriage 3, is provided with a suction unit 40, which will be described in detail later, and which performs a suction operation for suctioning ink from a nozzle opening of the ink jet recording head.

In addition, a non-printing area is provided with a recovery unit 50, which will be described in detail later, for recovering the ink adhered to the cleaning member. According to a first embodiment of the invention, the recovery unit 50 is provided in the non-printing area located at the same side as that of the suction unit 40.

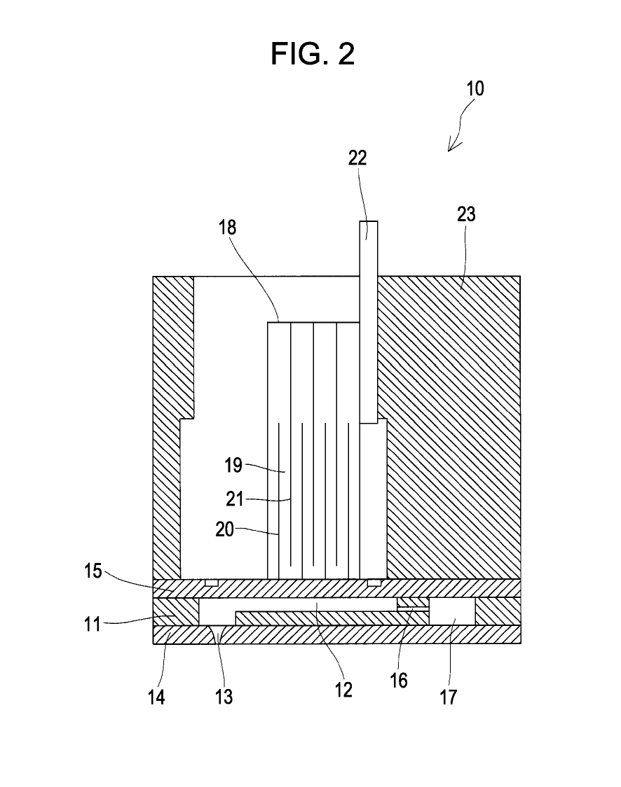

An ink jet recording head mounted in the aforementioned ink jet recording apparatus will now be described. FIG. 2 is a cross-sectional view illustrating an example of an ink jet recording head according to a first embodiment of the invention.

The ink jet recording head 10 shown in FIG. 2 is a type having a longitudinal vibration piezoelectric element, and a spacer 11 has a plurality of pressure generating chambers 12. Both sides of the spacer 11 are enveloped by a vibration plate 15 and a nozzle plate 14 having a nozzle opening 13 corresponding to each pressure generating chamber 12. In addition, the pressure generating chambers 12 are communicated to one another through each ink feed hole 16, and the spacer 11 has a reservoir 17 functioning as an ink chamber common to a plurality of the pressure generating chambers 12. The reservoir 17 is connected to an ink cartridge (not shown).

Meanwhile, on the other side of the pressure generating chamber 12 of the vibration plate 15, a leading end of each piezoelectric element 18 makes contact with an area corresponding to each pressure generating chamber 12. The piezoelectric element 18 is obtained by alternately stacking and interposing a piezoelectric material 19 and an electrode material 20 and 21 in a longitudinal direction to resemble a sandwich so that an inactive area which does not contribute to vibration is fastened to a fixation substrate 22. Furthermore, the fixation substrate 22, the vibration plate 15, the spacer 11, and the nozzle plate 14 are integrally fixed through a base frame 23.

In the ink jet recording head 10 constructed as described above, ink is supplied to the reservoir 17 through an ink path communicated to the ink cartridge, and the ink is distributed to each pressure generating chamber 12 through the ink feed hole 16. In practice, the piezoelectric element 18 is shrunk by applying a voltage to the piezoelectric element 18. As a result, the vibration plate 15 is deformed (e.g., raised in an upper direction in the drawing) together with the piezoelectric element 18 to allow the volume of the pressure generating chamber 12 to increase, so that ink is drawn into the pressure generating chamber 12. The ink is filled in the ink generating chamber 12 until the ink reaches the nozzle opening 13, and then, the piezoelectric element 18 is extended and returned to its original state by releasing the voltage applied to the electrode material 20 and 21 of the piezoelectric element 18 in response to the recording signal from the driving circuit. As a result, since the vibration plate 15 is also displaced and returned to its original state, the pressure generating chamber 12 is shrunk so that the internal pressure increases, and an ink droplet is discharged from the nozzle opening 13. In other words, according to a first embodiment of the invention, the longitudinal vibration piezoelectric element 18 is provided as a pressure generating element for generating pressure variation within the pressure generating chamber 12.

In such an ink jet recording head 10, since air bubbles generated in the ink during an initial installation, replacement, or printing operation of the ink cartridge 2A or 2B remain in the pressure generating chamber 12 and absorb pressure variation within the pressure generating chamber 12, an ink droplet may be inappropriately discharged, and a printing error such as a missing dot may be generated. Therefore, the non-printing area of the ink jet recording apparatus is provided with a suction unit 40 for suctioning the bubbles as well as the ink within the flow path from the nozzle opening 13 to the pressure generating chamber 12.

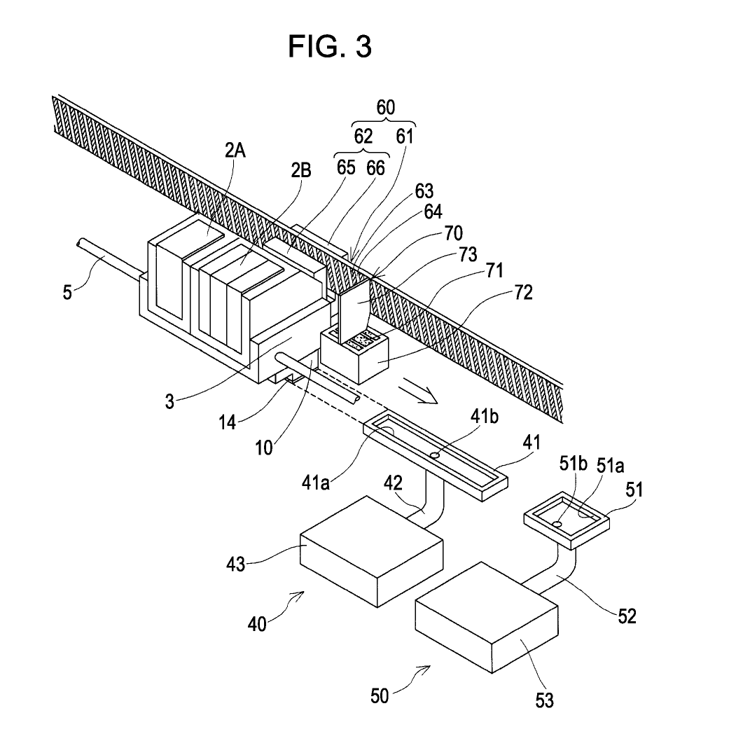

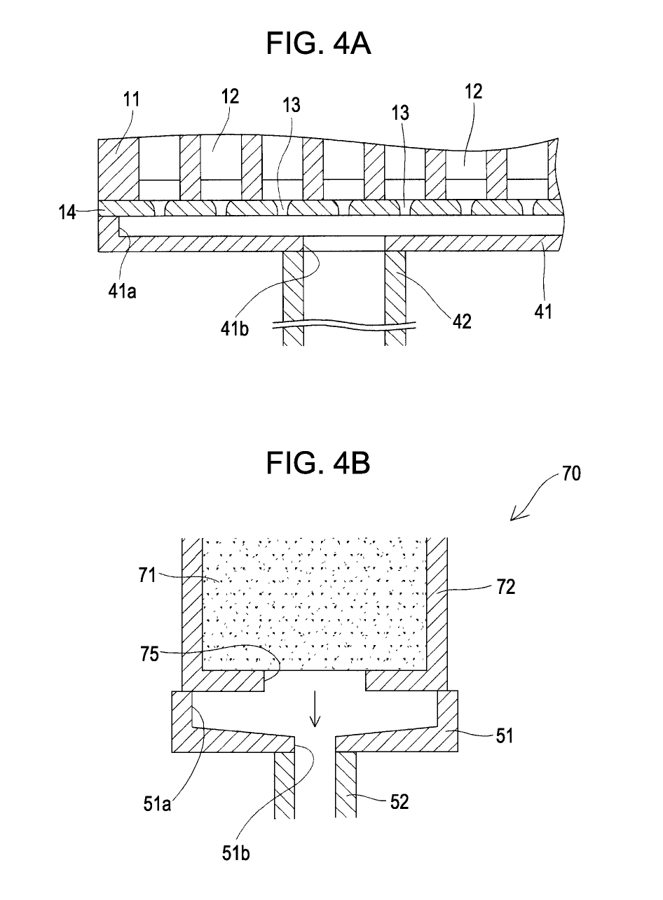

The suction unit 40 will now be described in detail. FIG. 3 is an enlarged perspective view illustrating main components of the ink jet recording apparatus, and FIGS. 4A and 4B are cross-sectional views illustrating a suction unit and a recovery unit.

Referring to FIGS. 3 and 4A, the suction unit 40 includes a cap member 41 which covers a surface opened by the nozzle opening 13 of the ink jet recording head 10 and a suction module 43 such as a vacuum pump connected to the cap member 41 through a suction pipe 42.

The cap member 41 is provided to face the nozzle plate 14 of the ink jet recording head 10 and covers all of a plurality of the nozzle openings 13.

The cap member 41 has a suction hole 41a which faces the nozzle plate 14 and is opened across all of the nozzle openings 13 as shown in FIG. 4A. The cap member 41 covers all of the nozzle openings 13 by allowing edges of the suction hole 41a to make contact with the surface of the nozzle plate 14. The cap member 41 has a communication hole 41b which communicates with the suction hole 41a on the opposite surface to the suction hole 41a, and the suction module 43 is connected to the communication hole 41b through the suction pipe 42.

In the suction unit 40 having the aforementioned construction, the edges of the suction hole 41a of the cap member 41 make contact with the surface of the nozzle plate 14, and the suction module 43 performs a suction operation by suctioning the ink remaining in the flow path such as the pressure generating chamber 12 from the nozzle opening 13 together with the air bubbles with the inside of the cap member 41 having a negative pressure. In addition, the cap member 41 covers the nozzle opening 13 at other timings than the suction operation such as a power-off or stand-by timing or on a regular basis to prevent the ink near the nozzle opening 13 from drying and thickening.

The ink jet recording apparatus I is provided with a linear encoder 60 as shown in FIGS. 1 and 3. The linear encoder 60 includes a linear encoder scale 61 having the same length as that of the carriage axis 5 along the movement direction of the carriage 3, i.e., in an axial direction of the carriage axis 5 and a detector 62 mounted in the carriage 3.

The linear encoder scale 61 is provided with a plurality of masking portions 63 arranged with a predetermined interval to mask light along a movement direction of the carriage 3 on one surface of a plate-shaped member made of transparent resin or glass or the like. Since a plurality of the masking portions 63 are provided with a predetermined interval on a transparent plate-shaped member, transmitting portions 64 which transmit light are provided between the neighboring masking portions 63. That is, the linear encoder scale 61 is provided with the transmitting portions 64 and the masking portions 63 alternately repeating along a movement direction of the carriage 3.

The detector 62 includes, for example, an irradiation portion 65 having a light-emitting element which irradiates light and a light-receiving portion 66 having a light-receiving element which receives light. The irradiation portion 65 and the light-receiving portion 66 are arranged to face each other with the linear encoder scale 61 being interposed therebetween. In the transmitting portions 64 of the linear encoder scale 61, the light irradiated from the irradiation portion 65 is received by the light-receiving portion 66. In the masking portions 63, the light irradiated from the irradiation portion 65 is masked by the masking portions 63, and is not received by the light-receiving portion 66. The movement of the carriage 3 makes the light-receiving portion 66 repetitively receive the light so that the movement position of the carriage 3 can be detected based on the number of times the irradiated light is received using the light-receiving portion 66. Further, the movement speed of the carriage 3 can be detected based on the light-receiving timing (i.e., the number of times received per unit time) using the light-receiving portion 66.

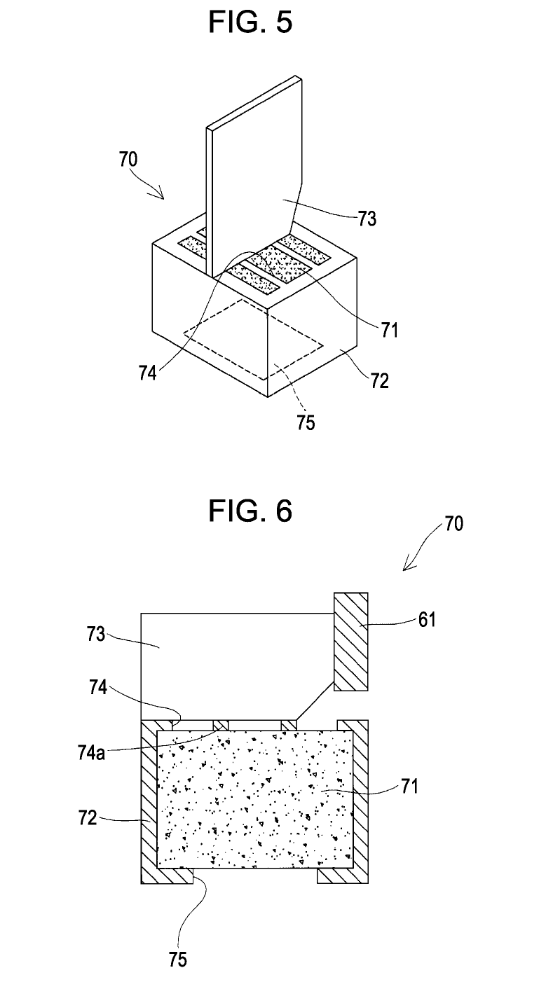

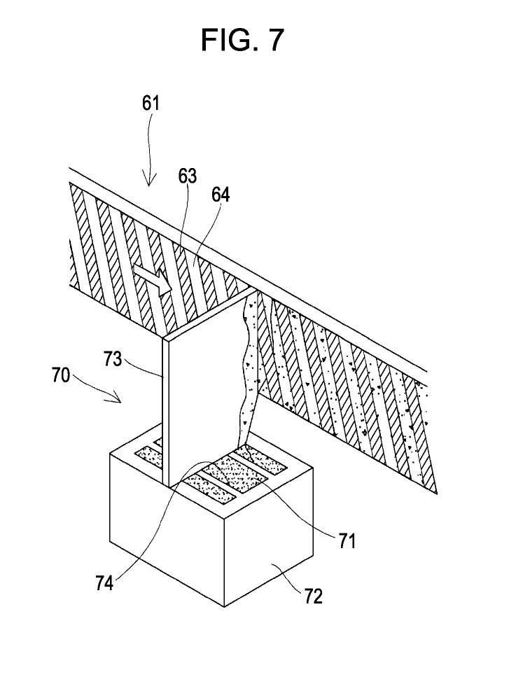

The carriage 3 is provided with a cleaning member 70 for cleaning the linear encoder scale 61. The cleaning member according to a first embodiment of the invention will now be described with reference to FIGS. 5 to 7. FIG. 5 is a perspective view illustrating a cleaning member, FIG. 6 is a cross-sectional view illustrating a cleaning member, and the FIG. 7 is a perspective view illustrating a cleaning state using the cleaning member.

Referring to FIGS. 5 and 6, the cleaning member 70 includes a storage section 72 which has a box shape for internally storing the absorber 71 and a deformable member 73 fixed on an upper surface of the storage section 72 in a vertical direction.

The deformable member 73 is a plate-shaped member made of an elastic material such as rubber or elastomer. One end functioning as the free end of the deformable member 73 makes contact with one surface of the linear encoder scale 61.

The storage section 72 has a box shape including a first opening 74 opened on the surface where the deformable member 73 is stored (i.e., an upper surface in a vertical direction according to a first embodiment of the invention) and a second opening 75 opened on a surface opposite to the deformable member 73 (i.e., a lower surface in a vertical direction according to a first embodiment of the invention).

The first opening 74 is partitioned to a plurality of portions by bridges 74a, and the deformable member 73 is stored on the bridges 74a which partition the first opening 74.

The second opening 75 has a size smaller than that of the absorber 71 so that the absorber 71 stored in the storage section 72 is exposed by the second opening 75 without dropping in a vertical direction.

The absorber 71 stored in the storage section 72 is made of a material including, for example, a porous material formed of resin (e.g., polyurethane) or fiber such as pulp, synthetic fiber, and dry pulp non-woven, capable of absorbing and storing a liquid such as ink.

The lateral surface of the storage section 72 is fixed on the lateral surface of the carriage 3 as shown in FIG. 3, and moves together with the carriage 3 in an axial direction of the carriage axis 5 so that the leading end of the deformable member 73 makes sliding-contact with the linear encoder scale 61.

Referring to FIG. 7, the leading end of the deformable member 73 of the cleaning member 70 slides on the surface of the linear encoder scale 61 along the movement of the carriage 3 to wipe off the liquid such as ink adhered to the linear encoder scale 61.

The liquid such as ink wiped off by the deformable member 73 downwardly moves in a vertical direction along the deformable member 73 due to its own weight, moves from the first opening 74 to the absorber 71, and is absorbed by the absorber 71.

The liquid such as ink absorbed by the absorber 71 is recovered by the recovery unit 50 provided in the non-printing area.

A recovery unit 50 according to a first embodiment of the invention will now be described with reference to FIGS. 3 and 4B. The recovery unit 50 according to a first embodiment of the invention has the same construction as that of the aforementioned suction unit 40. That is, the recovery unit 50 includes a cleaning cap member 51 provided in a vertically downward direction with respect to the cleaning member 70 and a cleaning suction module 53 such as a vacuum pump connected to the cleaning cap member 51 through a cleaning suction pipe 52 as shown in FIG. 3.

The cleaning cap member 51 faces the cleaning member 70 in a vertically downward direction and has a size that covers the second opening 75.

The cleaning cap member 51 faces the storage section 72 and has a cleaning suction hole 51a having a size that covers the second opening 75 as shown in FIG. 4B. The cleaning cap member 51 has the cleaning suction hole 51a and a cleaning communication hole 51b which communicates with the cleaning suction hole 51a on the opposite surface. The cleaning suction module 53 is connected the cleaning communication hole 51b through the cleaning suction pipe 52.

In the recovery unit 50 having the aforementioned construction, the cleaning suction hole 51a of the cleaning cap member 51 makes contact with the second opening 75 of the storage section 72 in order to allow the cleaning suction module 53 to perform the suction operation. The recovery operation is performed by suctioning the ink absorbed in the absorber 71 with the inside of the cleaning cap member 51 having a negative pressure.

While the suction unit 40 and the recovery unit 50 are separately provided according to a first embodiment of the invention, they may be partly or entirely combined because the suction unit 40 and the recovery unit 50 have the same construction as described above. For example, the cleaning suction module 53 of the recovery unit 50 may be commonly used with the suction module 43 of the suction unit 40. In addition, if the cap member 41 and the cleaning cap member 51 are integrated into a single cap member, both the suction and recovery operations can be performed using only a single cap member.

In the cleaning member 70 and the recovery unit 50, since the liquid such as ink adhered to the linear encoder scale 61 is wiped off by allowing the deformable member 73 of the cleaning member 70 to make sliding-contact with the linear encoder scale 61, and the removed liquid is stored in the absorber 71, it is possible to prevent the liquid wiped off by the deformable member 73 from dropping onto the recording sheet S during a printing operation and polluting the recording sheet S by the liquid such as ink. In addition, since the liquid absorbed by the absorber 71 can be recovered by the recovery unit 50 provided in a non-printing area, the amount of the liquid that can be absorbed by the absorber 71 does not become saturated, and pollution caused by the liquid such as ink on the recording sheet S can be reliably prevented. In addition, the recovery operation of the recovery unit 50 may be performed at a predetermined timing based on a driving condition of the ink jet recording head 10.

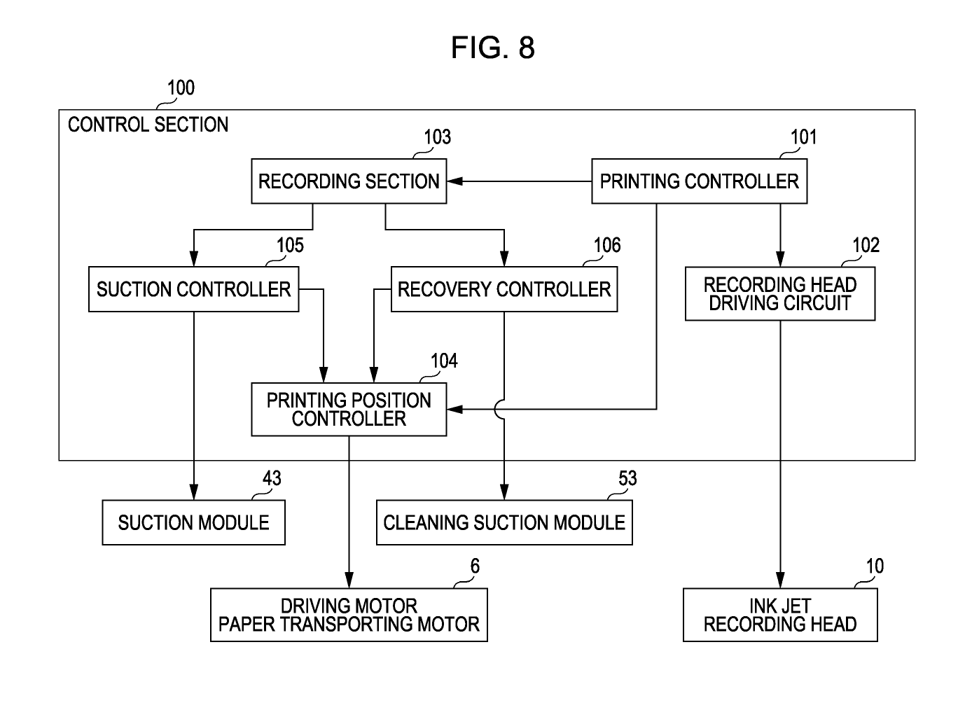

A control system of the ink jet recording apparatus I will now be described with reference to FIG. 8. FIG. 8 is a block diagram illustrating a control scheme of the ink jet recording apparatus.

Referring to FIG. 8, the control section 100 of the ink jet recording apparatus includes a printing controller 101, a recording head driving circuit 102, a memory section 103, a printing location controller 104, a suction controller 105, and a recovery controller 106.

The printing controller 101 controls a printing operation of the ink jet recording head 10. For example, a driving pulse is applied to the piezoelectric element 18 as a pressure generating element provided in the ink jet recording head 10 through the recording head driving circuit 102 based on the printing signal input from an external unit, and an ink droplet is discharged from the nozzle opening 13 of the ink jet recording head 10.

The printing controller 101 stores the driving condition for driving the ink jet recording head 10 on the memory section 103. It is noted that an example of the driving condition of the ink jet recording head 10 includes an ink consumption amount. According to a first embodiment of the invention, the ink consumption amount of the ink jet recording head 10 may be calculated based on the number of times the ink is discharged or the number of times the piezoelectric element 18 is driven using the printing controller 101. Needless to say, the ink consumption amount may be calculated based on other methods than the aforementioned number of times the ink is discharged without limitation. For example, the ink consumption amount may be calculated using a fluid level sensor prepared in the ink cartridge 2A and 2B corresponding to an ink storage. Based on the driving condition of the ink jet recording head 10 stored on the memory section 103, the section controller 105 and the recovery controller 106 perform the suction operation and the recovery operation which will be described later.

The printing position controller 104 determines the position of the ink jet recording head 10 in the main-scanning and sub-scanning directions during the printing and capping operations. Specifically, the printing position controller 104 determines the position of the ink jet recording head 10 in a main-scanning direction by driving the driving motor 6 and shifting the carriage 3 in a main-scanning direction. Further, the printing position controller 104 determines the position of the ink jet recording head 10 in a sub-scanning direction with respect to the recording sheet S by driving a paper transport motor (not shown) and shifting the recording sheet S in a sub-scanning direction. The printing position controller 104 shifts the recording sheet S in a sub-scanning direction while shifting the carriage 3 where the ink jet recording head 10 is mounted in a main-scanning direction during the printing operation. In capping, suction, and recovery operations, the carriage 3 where the ink jet recording head 10 is mounted is moved to the non-printing area where the suction unit 40 or the recovery unit 50 is provided.

The suction controller 105 controls the suction operation of the suction unit 40. That is, the suction controller 105 performs control such that the suction module 43 of the suction unit 40 is operated at a predetermined timing to allow the suction unit 40 to perform the suction operation for suctioning the ink near the nozzle opening 13 of the ink jet recording head 10. Specifically, the suction controller 105 performs control such that the ink jet recording head 10 is moved to an opposite position to the cap member 41 using the printing position controller 104, the ink jet recording head 10 is capped by the cap member 41, and the suction operation is performed by driving the suction module 43.

The recovery controller 106 controls the recovery operation of the recovery unit 50. That is, the recovery controller 106 performs control such that the cleaning suction module 53 of the recovery unit 50 is operated at a predetermined timing to allow the recovery unit 50 to perform the recovery operation for the ink stored in the cleaning member 70. Specifically, the recovery controller 106 performs control such that the cleaning member 70 (or the carriage 3) is moved to an opposite position to the cleaning cap member 51 using the printing position controller 104, the storage section 72 of the cleaning member 70 is capped by the cleaning cap member 51, and the recovery operation for the liquid such as ink absorbed by the absorber 71 is performed by driving the cleaning suction module 53.

The timings at which the suction controller 105 and the recovery controller 106 are allowed to perform the suction and recovery operations may be specified, for example, based on the driving condition in which the ink jet recording head 10 was driven. Since the driving condition of the ink jet recording head 10 has been storeed on the memory section 103 as described above, the suction controller 105 and the recovery controller 106 may perform the suction and recovery operations based on the driving condition stored on the memory section 103 at a predetermined timing.

For example, in a case where the ink consumption amount calculated based on the number of times the piezoelectric element 18 is driven by the printing controller 101 is stored on the memory section 103, the suction controller 105 and the recovery controller 106 may allow the suction or recovery operation to be performed when the ink consumption amount reaches a predetermined value.

In addition, in a case where the number of times the piezoelectric element 18 is driven is directly stored on the memory section 103, the suction controller 105 and the recovery controller 106 may allow the suction or recovery operation to be performed when an accumulative total of the number of times the piezoelectric element 18 is driven reaches a predetermined value.

The suction and recovery operations may be performed at an independent timing or the same timing. Needless to say, the timing (interval) for performing the suction or recovery operation is not limited to the ink consumption amount of the ink jet recording head 10 (i.e., the number of times the piezoelectric element 18 is driven), but the suction or recovery operation may be performed, for example, before and after the printing of a single recording sheet S, i.e., for every recording sheet S. In this case, the driving for the recording sheet S becomes a driving condition of the ink jet recording head 10.

As described above, according to a first embodiment of the invention, the cleaning member 70 is constructed to not only wipe off the liquid such as ink adhered to the linear encoder scale 61 using the deformable member 73 but also to absorb the liquid wiped off by the deformable member 73 using the absorber 71. Therefore, it is possible to prevent the liquid wiped off by the deformable member 73 from dropping onto the recording sheet S and polluting the recording sheet S. Since the liquid such as ink adhered to the linear encoder scale 61 is cleaned using the cleaning member 70, it is possible to allow the detector 62 to detect information regarding the speed or position of the ink jet recording head 10 (i.e., the carriage 3) at any time.

Since the liquid such as ink absorbed by the absorber 71 of the cleaning member 70 is recovered using the recovery unit 50 provided in the non-printing area, it is possible to prevent the ink from dropping from the absorber 71 during a printing operation and prevent the liquid absorption force of the absorber 71 from being deteriorated.

### Embodiment 2

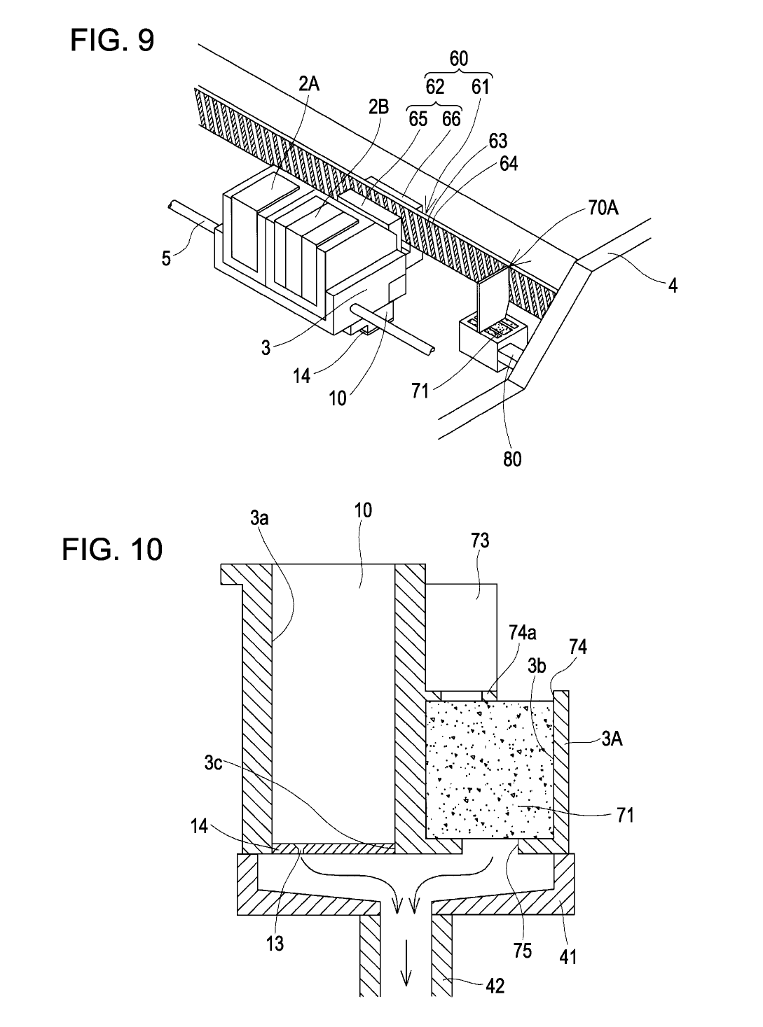

FIG. 9 is a perspective view illustrating a cleaning member and a recovery unit according to a second embodiment of the invention. Like reference numerals denote like elements throughout the first and second embodiments, and repeated description will be omitted.

Referring to FIG. 9, the cleaning member 70A according to a second embodiment of the invention is detachably installed at a lateral surface of one side of a movement direction of the carriage 3. The cleaning member 70A and the carriage 3 may be combined (installed) with or removed from each other using any method such as a mechanical engagement or a magnetic force.

The mainframe 4 of the ink jet recording apparatus I is provided with a storage unit 80 for storing the cleaning member 70A disengaged from the carriage 3. A method of storing the cleaning member 70A in the storage unit 80 may include any method such as a mechanical engagement or a magnetic force without limitation.

The timing for installing or removing the cleaning member 70A in or from the carriage 3 may be specified based on the driving condition, of the ink jet recording head 10, stored on the memory section 103 mounted in the control section 100 according to a first embodiment of the invention.

Since the cleaning member 70A and the carriage 3 are detachably combined as described above, the cleaning member 70A is able to clean the linear encoder scale 61 at a desired timing. In other words, when the linear encoder scale 61 is cleaned by the cleaning member 70A, the linear encoder scale 61 can be cleaned using the cleaning member 70A by installing the cleaning member 70A in the carriage 3 and moving the cleaning member 70A together with the carriage 3 in a main-scanning direction. On the other hand, when the linear encoder scale 61 is not cleaned by the cleaning member 70A, the cleaning member 70A may be separated from the carriage 3 and stand by in the non-printing area.

As a result, since the cleaning member 70A is able to clean the linear encoder scale 61 at only a desired timing without always sliding on the linear encoder scale 61, it is possible to prevent the linear encoder scale 61 from suffering defects such as flaws generated by making sliding-contact with the cleaning member 70A or scratches on the masking portion 63.

It is preferable that the timing at which the cleaning member 70A slides on the linear encoder scale 61 for cleaning is a timing other than the timing at which the ink jet recording head 10 discharges ink to perform a printing operation. That is, during the printing operation, the cleaning member 70A may be separated from the carriage 3 and stand by in the non-printing area. On the other hand, at timings other than the printing operation, e.g., when the printing operation is finished, or before the printing operation, the cleaning member 70A may be installed in the carriage 3 and able to clean the linear encoder scale 61. The recovery unit 50 (not shown) may perform the recovery operation when the cleaning member 70A cleans the linear encoder scale 61.

### Embodiment 3

FIG. 10 is a cross-sectional view illustrating a carriage according to a third embodiment of the invention. Like reference numerals denote like elements through the first to third embodiments, and repeated description will be omitted.

Referring to FIG. 10, the carriage 3A stores the ink jet recording head 10, the absorber 71, and the deformable member 73. That is, according to a third embodiment of the invention, the storage section 72 of the cleaning member 70 is integrated with the carriage 3A unlike a first embodiment of the invention.

Specifically, the carriage 3A has a cavity box shape provided with a head storage hole 3a for storing the ink jet recording head 10 and an absorber storage hole 3b for storing the absorber 71.

The head storage hole 3a and the absorber storage hole 3b are provided with a head opening 3c and a second opening 75, respectively, which opens toward the cap member 41 side. The head opening 3c and the second opening 75 are opened in the same surface and simultaneously capped by the cap member 41 which has a size to cover the head opening 3c and the second opening 75.

Further, a bridge 74a is provided in the side of the first opening 74 located in a vertically upper direction of the absorber storage hole 3b, and the deformable member 73 is stored on the bridge 74a.

If the carriage 3A is constructed according to first and second embodiments of the invention, it is unnecessary to separately prepare the suction unit 40 for suctioning the ink within the ink jet recording head 10 and the recovery unit 50 for suctioning the liquid of the absorber 71 of the cleaning members 70 and 70A unlike the first and second embodiments of the invention. For example, a single suction unit 40 can be used to perform both the suction and recovery operations at the same time. As a result, it is possible to reduce cost.

### Other Embodiments

While the first to third embodiments of the inventions have been described above, the basic structure of the invention is not limited thereto. For example, while the cleaning members 70 and 70A include the deformable member 73 and the absorber 71 according to the first to third embodiments of the invention, the cleaning members 70 and 70A are not particularly limited to this configuration, but may include, for example, only the deformable member 73 or only the absorber 71. When the cleaning members 70 and 70A include only the absorber 71, the absorber 71 may be arranged to slide on the linear encoder scale 61. In addition, when the absorber 71 directly makes sliding-contact with the linear encoder scale 61, the liquid such as ink absorbed and stored in the absorber 71 may harden as time goes by. If the hardened liquid slides on the linear encoder scale 61, it is highly probable that defects, such as flaws in the linear encoder scale 61 or scratches on the masking portion 63, may be generated. However, according to the invention, since the recovery unit 50 recovers the liquid such as ink absorbed in the absorber 71, it is possible to diminish defects generated by making sliding-contact between the absorber 71 and the linear encoder scale 61.

While, according to the first to third embodiments of the invention, the recovery operation is performed at a predetermined timing based on the driving condition of the ink jet recording head 10, the invention is not limited thereto. For example, the recovery operation may be performed whenever a predetermined time is elapsed after power is turned on. Since it is considered that the linear encoder scale 61 is primarily polluted by the ink discharged from the ink jet recording head 10, it is possible to effectively perform the cleaning and recovery operations of the linear encoder scale 61 by enabling the recovery operation to be performed based on the driving condition of the ink jet recording head 10.

While, according to the first to third embodiments, the cleaning members 70 and 70A are stored in the carriage 3, the cleaning members 70 and 70A may be stored in another carriage different from the carriage 3 which stores the ink jet recording head 10.

While, according to the first to third embodiments, a longitudinal vibration piezoelectric element 18 is used as a pressure generating element for generating pressure variation within the pressure generating chamber 12, the invention is not limited thereto. For example, a thick-film type piezoelectric element formed by attaching a green sheet or a thin-film type piezoelectric element formed by depositing an electrode and a piezoelectric layer using film formation of lithography may be used as a pressure generating element for generating pressure variation within the pressure generating chamber 12. Furthermore, as a pressure generating element, a heating element may be arranged within the pressure generating chamber to discharge a liquid droplet from the nozzle opening using the bubbles generated by the heat from the heating element. Alternatively, a so called electrostatic actuator, in which static electricity is generated between a vibration plate and an electrode, and the vibration plate is deformed by the electrostatic force to discharge a liquid droplet from the nozzle opening, may be used.

While the invention is widely applicable to a general liquid ejecting apparatus having a wide liquid ejecting head, the invention may also be applied to other liquid ejecting apparatuses such as an image recording apparatus such as a printer, a color material ejecting apparatus used to manufacture a color filter of a liquid crystal display, an electrode material ejecting apparatus used to manufacture an electrode of an organic EL (electroluminescent) display or a FED(field emission display), and a biological organic material ejecting apparatus used to manufacture a biochip.

What is claimed is:

1. A liquid ejecting apparatus comprising:
a liquid ejecting head that performs liquid ejection with respect to an ejection target medium;
a carriage that reciprocates with the liquid ejecting head being mounted;
a linear encoder that has a linear encoder scale extending in a movement direction of the carriage and a detector which detects the linear encoder scale;
a cleaning member that cleans the linear encoder scale; and
a recovery unit that recovers the liquid adhered to the cleaning member in a non-ejection area other than an ejection area for performing ejection with respect to the ejection target medium.

2. The liquid ejecting apparatus according to claim 1, comprising:
a memory section that stores a driving condition of the liquid ejecting head; and
a control section that drives the cleaning member based on the driving condition stored in the memory section.

3. The liquid ejecting apparatus according to claim 1, wherein the cleaning member slides on the linear encoder scale along reciprocation of the carriage.

4. The liquid ejecting apparatus according to claim 1, wherein the cleaning member and the carriage are detachably provided so that the cleaning member stands by in a non-ejection area at an ejection timing when the liquid ejecting head ejects a liquid, and the cleaning member is installed in and moved together with the carriage at a non-ejection timing when the liquid ejecting head does not eject a liquid.

5. The liquid ejecting apparatus according to claim 1, wherein the cleaning member is installed in the carriage and constructed such that the liquid cleaned by the cleaning member is delivered to the same surface as a nozzle surface on which a nozzle opening, for ejecting the liquid of the liquid, ejecting head is provided, and, when a suction operation is performed, by a suction unit which covers the nozzle opening, on the nozzle surface, the suction unit simultaneously suctions the liquid cleaned by the cleaning member.

6. The liquid ejecting apparatus according to claim 1, wherein the cleaning member has:
a deformable member that is elastically deformable and makes sliding-contact with the linear encoder scale; and
an absorber that is provided in the deformable member and absorbs the liquid recovered by the deformable member through the sliding-contact.
